(19) United States
(12) Patent Application Publication
(10) Pub. No.: US 2025/0198776 A1
(43) Pub. Date: Jun. 19, 2025

(54) SYSTEM AND METHODS FOR DELIVERING FUELING PLANS

(71) Applicant: Adeia Guides Inc., San Jose, CA (US)

(72) Inventors: Christopher Phillips, Hartwell, GA (US); Dhananjay Lal, Englewood, CO (US); Reda Harb, Tampa, FL (US)

(21) Appl. No.: 18/541,276

(22) Filed: Dec. 15, 2023

(51) Int. Cl. G01C 21/34; B60W 30/14; G01C 21/36

(52) U.S. Cl. CPC G01C 21/3469; B60W 30/146; G01C 21/3617; G01C 21/3679; G01C 21/3697; B60W 2530/10; B60W 2530/209; B60W 2530/213

(57) ABSTRACT

Systems and methods are disclosed for generating a fueling plan based on navigation data for the trip, fuel type data for the vehicle, and fuel price data for fuel locations within a geographic threshold of the trip. The fueling plan may include a selected fuel location. For instance, the system may determine, based on the fuel type data, that the vehicle cannot reach the selected fuel location. In response to this determination, the system may automatically configure the vehicle to reduce fuel consumption. In some embodiments, this may include limiting acceleration of the vehicle, limiting speed of the vehicle, or modifying the operation of non-critical systems and services, such as shutting down the AC, opening or closing windows of the vehicle, limiting the number of built-in screens which are consuming content or disabling the functionality of some or all the screens, disabling media streaming functionality or auxiliary functionality such as pairing a phone with the infotainment system, disabling device chargers, etc.

### BACKGROUND

The present disclosure is directed towards systems and methods for creating a fueling plan for a long trip. Systems and methods are provided herein for creating a fuel plan based on navigation data for a trip, fuel type data for the vehicle, and fuel price data for various fueling locations.

### SUMMARY

Vehicle efficiency, fuel consumption, and fuel costs are important factors for drivers who travel long distances, e.g., for commercial or recreational purposes, but are not necessarily even monitored. Many modern vehicles are equipped to capture data related to fuel consumption and, e.g., determine a range or distance that the vehicle can travel based on such information. For instance, a typical gasoline-powered sedan might be able to travel over 450 miles on a single tank of 91 octane fuel, depending on e.g., the vehicle and type of driving. In such cases, a variable range number may be displayed on the dashboard near the fuel gauge. A range may be a rough estimate based on a recent miles-per-gallon calculation and too speculative to determine a concrete plan to refuel.

Generally, existing navigation approaches do not provide adequate solutions for optimizing fuel plan and route selection, as they either rely on inaccurate or outdated data, or do not consider all the relevant factors that affect fuel efficiency and cost. In typical approaches, a fuel range may be calculated separately from any navigation routes or information, and vice versa.

For instance, some approaches may only use the average fuel consumption rate of the vehicle, or the distance and traffic conditions of the route, without taking into account the real-time data from the gas tank, the GPS location of the vehicle, the ECU data via an OBD II reader, the navigation data for the destination, or the prices for fuel at specific gas stations along the route. Such data is essential for creating a fuel plan and an optimal route that can minimize fuel consumption and cost, as they can reflect the actual situation of the vehicle, the environment, and the market.

In some approaches drivers may encounter situations where they run out of gas, have to pay higher prices for fuel, or have to deviate from their planned route to find gas stations. These situations may cause inconvenience, delay, or extra expense for the drivers, and may also pose safety or environmental risks. For example, running out of gas may leave the drivers stranded on the road, paying higher prices for fuel may reduce the profitability or budget of professional drivers, and deviating from the planned route to find gas stations may increase the travel time, distance, and emissions of the drivers. There exists a need to generate fuel plans to reduce fuel usage, maximize vehicle efficiency, and minimize emissions. There is a need for a navigation software that can use all the relevant data and factors to create a fuel plan and an optimal route for driving a vehicle a long distance, taking into account the real-time fuel use data, the GPS location, the navigation data for the destination, and the prices for fuel at specific gas stations along the chosen route.

As disclosed herein, a fueling plan may be generated based on navigation data for the trip, fuel type data for the vehicle, and fuel price data for fuel locations within a geographic threshold of the trip. The fueling plan may include a selected fuel location.

In some embodiments, the system may determine, based on the fuel type data, that the vehicle cannot reach the selected fuel location. In response to this determination, the system may automatically configure the vehicle to reduce fuel consumption. In some embodiments, this may include limiting acceleration of the vehicle, limiting speed of the vehicle, or modifying the operation of non-critical systems and services, such as shutting down the AC, opening or closing windows of the vehicle, limiting the number of built-in screens which are consuming content or disabling the functionality of some (e.g., screens in the back of the car but not the front infotainment system that is used to display maps, for example) or all the screens, disabling media streaming functionality or auxiliary functionality such as pairing a phone with the infotainment system, disabling device chargers, etc.

In some embodiments, the selected fuel location may be preconfigured with fuel type data for the vehicle and an amount of fuel.

In some embodiments, navigation data may include a destination, a starting location, a plurality of routes, traffic data, and road condition data. In some embodiments, the navigation data may include a driver profile. In some embodiments, this driver profile may include a user preference to minimize a cost for the trip. This preference may cause the fueling plan to determine a route which minimizes the cost of fuel for the trip. In some embodiments, this driver profile may include a user preference to minimize a duration for the trip. This preference may cause the fueling plan to determine a route which minimizes the duration of the trip.

In some embodiments, the fuel type data for the vehicle may comprise a vehicle type, a vehicle VIN, a preferred fuel composition for the vehicle, a current fuel level, and a vehicle weight. In some embodiments, fuel composition may include the fuel grade based on octane level, such as premium fuel or regular fuel. In some embodiments, the fuel may be based on ethanol content. As an example, Flex Fuel vehicles may use E85 which is 15% ethanol vs 10% for non E85.

In some embodiments, the fuel price data for the fueling locations may include receiving an offer for a discount on fuel at a particular fueling location. In some embodiments, the fuel price data is determined in real time.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows a block diagram representing a fueling plan user interface and computing device components and dataflow therebetween for generating a fueling plan for a trip, in accordance with some embodiments of the disclosure;

FIG. 2 shows a block diagram representing an engine control unit range calculation module, in accordance with some embodiments of the disclosure;

FIG. 3 shows a fueling plan user interface presented to a user in a list view, in accordance with some embodiments of the disclosure;

FIG. 4 shows a fueling plan user interface presented to a user in a map view, in accordance with some embodiments of the disclosure;

FIG. 5 shows a fueling plan user interface presented to a user in chart view based on progress, in accordance with some embodiments of the disclosure;

FIG. 6 shows a fueling plan user interface presented to a user in a map view based on progress, in accordance with some embodiments of the disclosure;

FIG. 7 shows an exemplary overlay on a fueling plan user interface with an updated fuel price for the trip which has decreased, in accordance with some embodiments of the disclosure;

FIG. 8 shows an exemplary overlay on a fueling plan user interface with an updated fuel price for the trip which has increased, in accordance with some embodiments of the disclosure;

FIG. 9 shows an exemplary overlay on a fueling plan user interface with a custom offer for a discount on fuel, in accordance with some embodiments of the disclosure;

FIG. 10 shows a flowchart of illustrative steps involved in generating a fueling plan, in accordance with some embodiments of the disclosure;

FIG. 11 shows a flowchart of illustrative steps involved in generating a fueling plan based on minimizing cost or maximizing convenience, in accordance with some embodiments of the disclosure;

FIG. 12 shows a flowchart of illustrative steps involved in receiving fueling price data, in accordance with some embodiments of the disclosure;

FIG. 13 shows a flowchart of illustrative steps involved in generating a fueling plan based on maximizing convenience for a trip, in accordance with some embodiments of the disclosure; and

FIG. 14 shows a flowchart of illustrative steps involved in generating a fueling plan based on minimizing cost for a trip, in accordance with some embodiments of the disclosure.

### DETAILED DESCRIPTION

Drivers regularly make long distance trips which require refueling along the path in order to reach the destination. For example, a driver may want to travel more than 50 miles from their home but only have enough fuel to travel for 20 miles. These trips may be for work, vacations, sightseeing, visiting friends or relatives, recreation, etc. The average gas tank lasts between 300 and 400 miles of travel. Electric vehicles have ranges up to 100 miles or even 300 miles. Any trips longer than this will require at least one refuel along the way.

While users may be able to determine nearby refueling stations along their route through navigation apps, these apps do not integrate range knowledge of the vehicle nor user preference for optimization of cost or convenience. A user may choose to wait until their fuel level or charge level falls below a threshold to refuel or recharge. However, if that threshold is too low then they may be pressed to choose a gas station which is suboptimal due to cost or deviation from the route. They may be forced to use a refueling station which does now allow for minimizing the cost of the trip or causes them to deviate further off the route than other options and increase the length of the trip.

Systems and methods are described herein for creating a fueling plan based on navigation data, fuel type data, and/or fuel price data.

Navigation data may include a starting point for the trip, a destination, stops along the way, possible routes between the starting point and destination, traffic data, driver preference for a route, a driver profile, and/or any other data useful for navigating the trip. The driver profile may include information relating to the driver such as typical fuel consumption when driving, driving behaviors, preferences for a certain route, preference to optimize cost of a trip, preference to minimize a distance traveled on a trip, preference to minimize travel time of a trip, and/or any other driver preferences. In an embodiment, the driver profile may be based on a previous driving history. In an embodiment, if a trip will include multiple drivers then there may be multiple driver profiles which switch as drivers switch. In an embodiment, if a trip will include multiple drivers then there may be multiple driver profiles and one is selected as the dominant profile for calculating the fueling plan. In an embodiment, this driver profiles may include driving history for each driver with driving characteristics which change the amount of fuel required to drive a certain distance. For example, when a first driver is driving the vehicle may achieve 28 miles per gallon (MPG) while when a second driver is driving the vehicle may only achieve 24 MPG.

Fuel type data may include determining the type of fuel the vehicle in use operates with. A required fuel type may be gas, diesel, E85, octane 87/89/93, or any other fuel type. For example, a vehicle may prefer a grade of gasoline based on the octane level or the vehicle may be an electric vehicle and require charging. Fuel type data may also include the vehicle type, a vehicle VIN, a current fuel level determined from the engine control unit (ECU), a vehicle weight, whether the vehicle is towing additional objects, and/or any other features which will determine the type of fuel needed and consumption of the fuel.

Fuel price data may include prices for fuel from multiple fueling locations. These prices may be provided by the fueling locations themselves, a public database, or crowdsourcing from drivers themselves that observe fuel prices. In an embodiment, fuel price data may include an offer from a particular fueling location for a discount.

In an embodiment, the fueling plan may be presented to the user by a navigation service on a personal device such as a smart phone, tablet, laptop, computer, or any other personal electronic device. In an embodiment, the fueling plan may be presented to the user by an automotive original equipment manufacturer (OEM) on a user interface sub-system that is directly integrated with the vehicle.

In an embodiment, the fueling plan may be utilized to pre-configure a pump or specific charger with the amount and type of fuel. For example, carmakers or car rental agencies can lock in a specific grade type (e.g., 89-90) in order to prevent drivers from pumping in the undesired gasoline grade into their fuel tank or diesel or to prevent driver from accidentally putting gasoline into a diesel-powered vehicle. This could be done to prevent voiding a warranty, for example. Such restrictions can be removed after the warranty expires. In the case of diesel engines, accidental gasoline selection and fueling will leave the driver stranded and void the warranty. Even if such a feature is seen as forcing the car owner to use a specific grade of gas (and not implemented), the car can log the selected gasoline grade and warn the user if they should select a lower grade than what is recommended. For example, a fueling record is created that includes the amount of fuel that was transferred into the vehicle's fuel tank along with the type of fuel, location of the fuel station, pump number, date/time, and/or total cost.

In some embodiments, when a user scans a QR code at a fueling location or a particular pump, the fuel pump or charger is preconfigured with the amount and/or type of fuel. In some embodiments, scanning this QR code will activate a personalized discount. In some embodiments, a user is directed by the fueling plan to a particular pump which is preconfigured with the amount and type of fuel. In some embodiments, a user may communicate with a virtual assistant/smart assistance, e.g. Alexa, Google Assistant, Siri, etc., to be navigated to a pre-configured pump or to indicate which pump the user is at in order to configure the pump. When configuring a pump for fueling, the vehicle refueling service may communicate with a pump controller. The pump controller may be associated with a gas station or multiple gas stations, or the pump controller maybe a pump at the gas station. The pump controller is aware of the location of the vehicle. For example, the controller may be aware of the gas station location, gas station ID, pump ID, or any other indicator of location. In some embodiments, the controller may become aware of the location when the vehicle is in refuel mode. In some embodiments, the vehicle may share this data with the controller automatically. In some embodiments, the fuel pump is pre-configured based on data shared by the vehicle, such as fuel type, fuel grade, fuel amount, a loyalty card account, etc.

The above embodiments can also apply to electric vehicles (EV). The EV itself can alert the driver when the battery is at a level that is consistent with the charging plan for the trip. EV can have an additional feature that accounts for how busy some charging stations are and can then alter the charging plan. For example, the fueling plan might remove a busy station from the charging plan while rebalancing how much charging is needed at the other charging stations. In such a case, the fueling plan is dynamic and responsive to unexpected factors.

In some embodiments, a vehicle can operate in a “Gas Station Mode” or “Refueling Mode” when in the vicinity of a gas station or based on user input. For example, the vehicle may guide the driver to the appropriate pump or charger based on detecting an empty space and/or the location of the fuel door. Similarly, the car can drive to the fuel pump or charger after a payment preauthorization has been obtained. In some embodiments, the vehicle may identify a pump with no vehicles on a side of it, similar to a park assist mode. In some embodiments, the vehicle may take into account which side of the vehicle the fueling cap is on and ensure that the fuel cap is on the same side as the fuel nozzle of the pump.

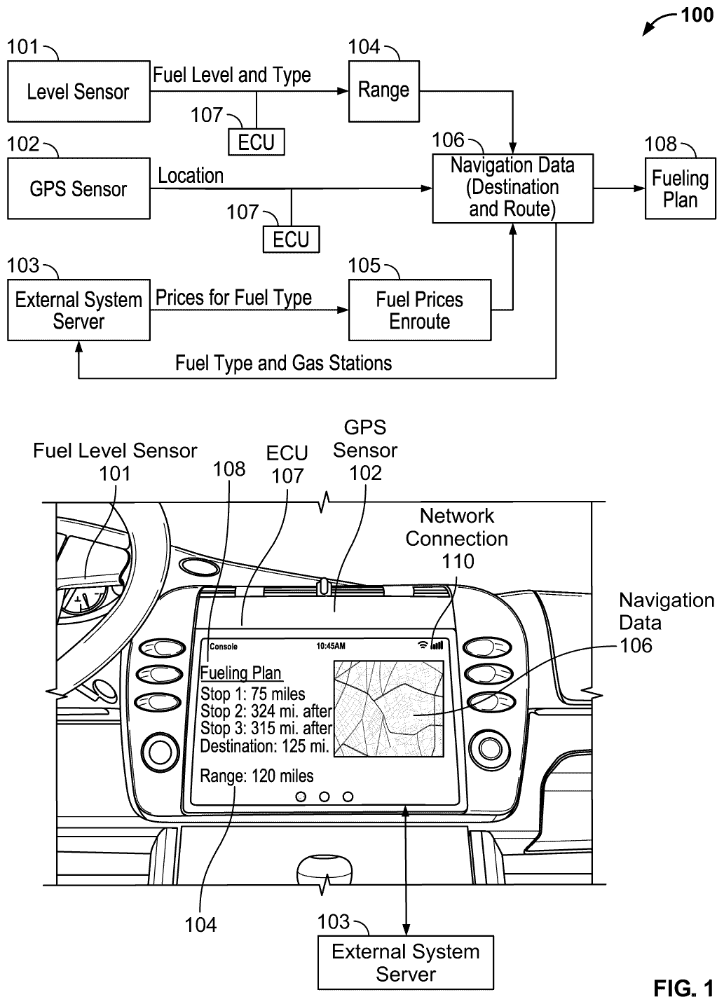

FIG. 1 shows a block diagram representing a fueling plan user interface and computing device components and dataflow therebetween for generating a fueling plan for a trip, in accordance with some embodiments of the disclosure. Fueling plan system 100 uses information including navigation data, fuel type data, and fuel price data to generate fueling plan 108.

Fuel type data includes information such as type of fuel used by the vehicle and the current fuel level as gathered by a level sensor and represented by fuel gauge 101. Fuel type data such as the vehicle type, a vehicle VIN, a current fuel level, the vehicle weight, and all other attributes intrinsic to the vehicle's fuel system may also be determined by ECU 107. This data may be used to calculate the range of the vehicle. The range of the vehicle is the distance the vehicle estimates it may be able to cover with the current amount of fuel, rate of fuel consumption, and other vehicle specific data. Navigation data such as the starting point, destination, stops, route, and traffic data are determined by global positioning system (GPS) sensor 102 and/or ECU 107.

Fuel price data may include data on the price of fuel, including the preferred fuel for the vehicle and other types of fuel, at various fuel locations, and all other extrinsic attributes of refueling options such as gas stations, EV charging stations, locations of fueling locations, and the type of fuel or charging available. The fuel price data comes from external system server 103. These fuel locations may include gas stations or charging stations. In some embodiments, the fuel locations may be selected based on a geographic threshold from the route by fuel prices enroute block 105. For example, the fuel locations may be limited to fueling locations which are less than 20 miles away from the planned route. In some embodiments, the fuel locations are limited to locations which offer the preferred fuel type for the vehicle. ECU 107 communicates with external system server 103 through network connection 110. Vehicle range 104, GPS sensor data 103, and fuel prices enroute 105 generate navigation data 106 which is used to generate fueling plan 108.

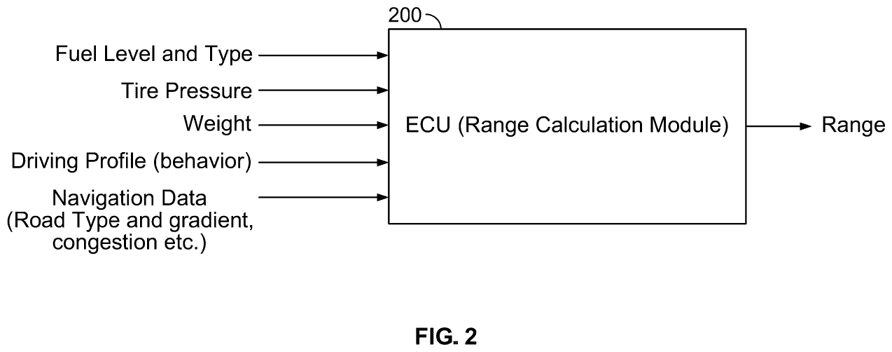

FIG. 2 shows a block diagram representing an engine control unit range calculation module, in accordance with some embodiments of the disclosure. An accurate calculation of range of a vehicle is necessary for determining optimal locations for fuel stops. The system must know what fueling locations can be reached with the current fuel level and how long until the vehicle runs out of fuel. Engine control unit (ECU) 200 takes in data inputs including fuel level and type, tire pressure, vehicle and cargo weight, driving profile data, and navigation data. Navigation data may include road types, such as a dirt road, paved road, etc., and traffic data, such as congestion. This information impacts the rate of fuel consumption. For example, stop and go traffic causes a vehicle to consume more fuel in a short distance than a continuous flow of traffic. In some embodiments, a range calculation module may be loaded into ECU 200 which has been derived from experimental testing. For example, a weighted polynomial function with input parameters weighted and an exponent may be used. In some embodiments, artificial intelligence (AI) and/or machine learning (ML) models may be trained on experimental data. For example, a deep neural network (DNN) may be used to generate the range output.

ECU 200 may also read out vehicle information, such as the vehicle identification number (VIN). In some embodiments, this may be read into a VIN decoder. The VIN decoder may provide data such as the make, model, and engine type of the vehicle. This information may be used to determine a preferred or required fuel type for the vehicle.

In some embodiments, the vehicle ECU may activate a power-saving mode which reduces fuel consumption in order to increase the range of the vehicle by reducing operation of non-critical systems. For example, an adjustment to the powertrain system such as an ECO mode which reduces responsiveness of acceleration pedal and limits power consumption and transfers may reduce fuel consumption and increase range. Similarly, an adjustment to the climate control system such as reducing the AC or opening or closing he windows may be made. increasing set temperature when driving in hot conditions may also reduce fuel consumption. The system may calculate an “extended range” for a “power saving mode” and use this to increase the reachable set of fueling stations. If the offer is received from a fueling station in the extended range but not in the normal range, then the vehicle UI may present this to the user. If this is the recommended option, for example based on a best/lowest price for the fuel type requirement, and the user acknowledges that this is the option they prefer, then the system may initiate the “power save” mode, adjusting the parameters of different automobile subsystems such as powertrain, climate control, infotainment etc. to reach this selected gas station. In some embodiments, automatically configuring the vehicle to reduce fuel consumption comprises one or more of limiting acceleration of the vehicle, limiting speed of the vehicle, and reducing operation of non-critical systems which consume fuel.

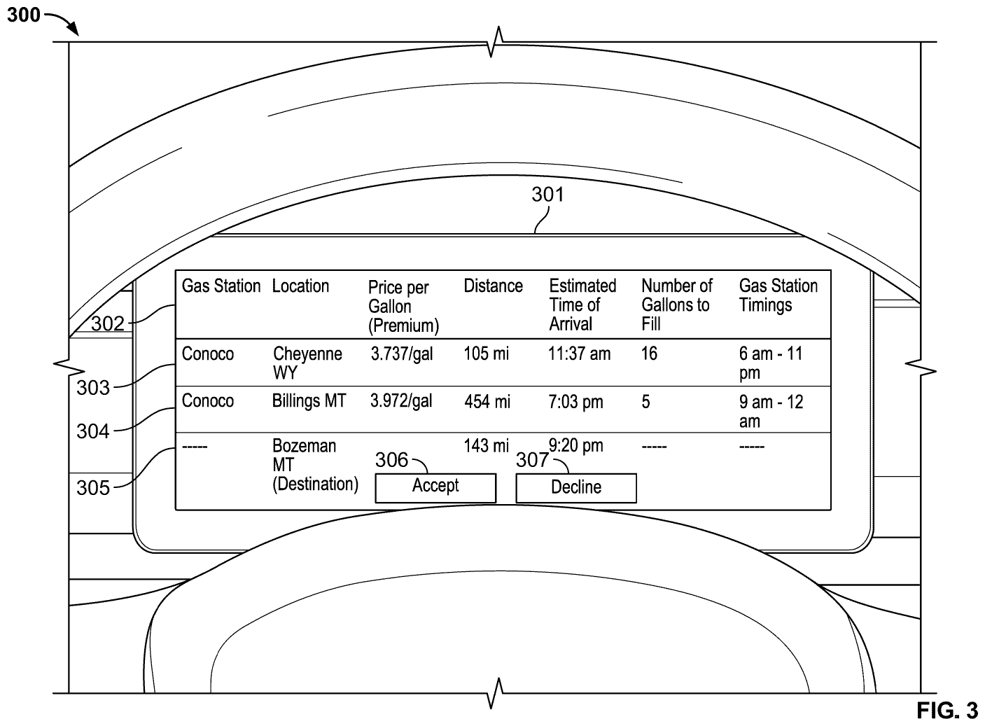

FIG. 3 shows a fueling plan user interface presented to a user in a list view, in accordance with some embodiments of the disclosure. Display 301 is shown as an automotive original equipment manufacturer (OEM) device/user interface (UI) which is directly integrated with the vehicle. In an embodiment, the fueling plan may be presented to the user on a display on a personal device such as a smart phone, tablet, laptop, computer, or any other personal electronic device.

In example fueling plan user interface 300, the display shows that driver intends to start in Denver, CO and drive to their destination in Bozeman, MT. The user may enter preferences and constraints for the fueling plan. For example, the user has input preferences that the fueling stops occur at least more than 100 miles apart. In example fueling plan user interface 300, the display shows a route that is optimizing the fueling stops for the lowest cost for fuel. In some embodiments, fueling plan user interface 300 may be presented to the user when they request it. In some embodiments, fueling plan user interface 300 may be presented to the user when they begin their trip.

In example fueling plan user interface 300, with the preferences and constraints above, the system displays a fueling plan based on a determination that fuel prices in Cheyenne, WY and Billings, MT are lower than surrounding regions on the route. The fueling route is calculated in a way which determines the optimal amount to fill up at these locations. Data header 302 defines the information presented to the user, including the brand of fueling location, location of fueling location, price of fuel at the fueling location, distance to a stop from the previous stop, estimated time to the stop, an amount of fuel to acquire at the fueling location, and hours of operation of the fueling location. Entry 303 details the information for the planned stop in Cheyenne, WY and entry 304 details the information for the planned stop in Billings, MT. The amount of fuel at each location is calculated to purchase the minimum necessary at more expensive rates in order to reduce cost of fuel for the trip, based on a user preference to minimize the cost of fuel for the trip. Accept option 306 allows a user to accept the presented fueling plan. Decline option 307 allows a user to decline the presented fueling plan. In some embodiments, a user may be prompted to enter additional information to generate a new fueling plan after declining the presented fueling plan.

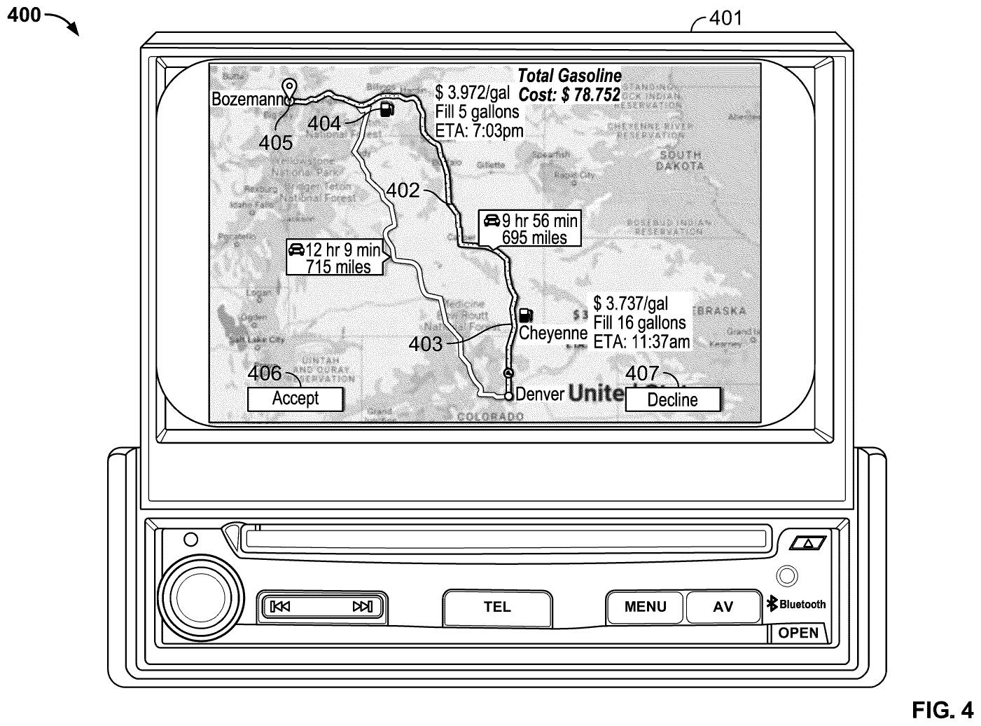

FIG. 4 shows a fueling plan user interface presented to a user in a map view, in accordance with some embodiments of the disclosure. Display 401 is shown as an automotive original equipment manufacturer (OEM) which is directly integrated with the vehicle. In an embodiment, the fueling plan may be presented to the user on a display on a personal device such as a smart phone, tablet, laptop, computer, or any other personal electronic device.

In example fueling plan display 400, the driver intends to start in Denver, CO and drive to their destination in Bozeman, MT. The user may enter preferences and constraints for the fueling plan. For example, the user has input preferences that the fueling stops occur at least more than 100 miles apart. In example fueling plan user interface 400, the display shows a route that is optimizing the fueling stops for the lowest cost for fuel. In some embodiments, fueling plan user interface 400 may be presented to the user when they request it. In some embodiments, fueling plan user interface 400 may be presented to the user when they begin their trip. In an embodiment, example fueling plan display 400 may also include an amount of fuel to be purchased at each fueling location.

In example fueling plan user interface 400, with the preferences and constraints above, the system displays a fueling plan based on a determination that the fuel prices in Cheyenne, WY and Billings, MT are lower than surrounding regions on the route. Route line 402 shows the user the route which will be taken on the trip. Stop indicator 403 indicates a planned stop in Cheyenne, WY and stop indicator 404 indicates a planned stop in Billings, MT. Accept option 406 allows a user to accept the presented fueling plan. Decline option 407 allows a user to decline the presented fueling plan. In some embodiments, a user may be prompted to enter additional information to generate a new fueling plan after declining the presented fueling plan.

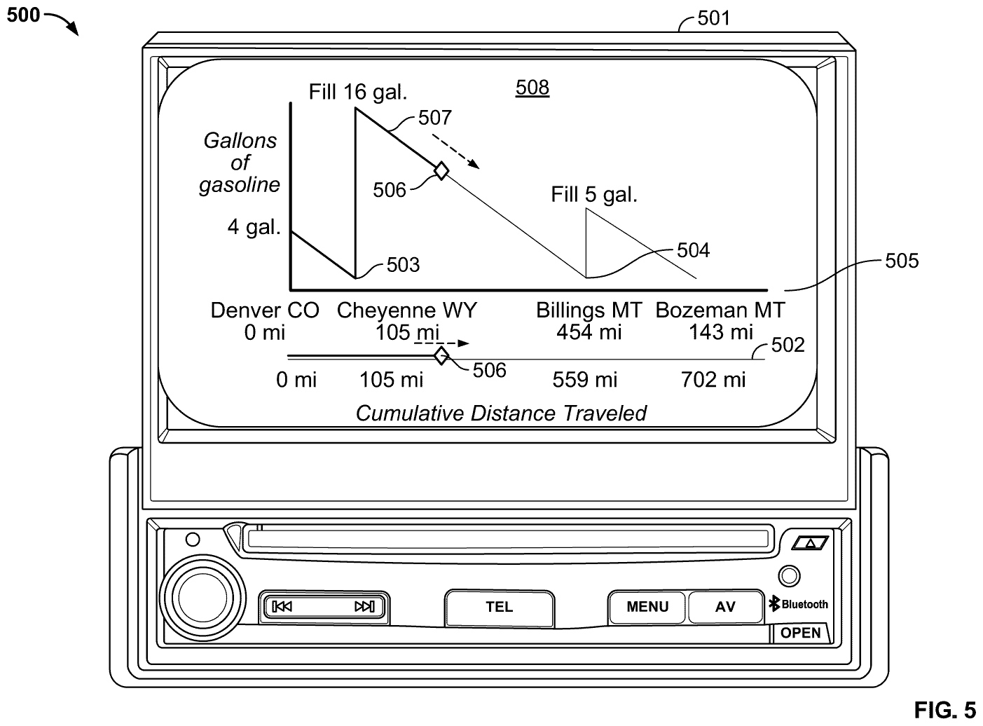

FIG. 5 shows a fueling plan user interface presented to a user in chart view based on progress, in accordance with some embodiments of the disclosure. Display 501 is shown as an automotive original equipment manufacturer (OEM) device which is directly integrated with the vehicle. In an embodiment, the fueling plan may be presented to the user on a display on a personal device such as a smart phone, tablet, laptop, computer, or any other personal electronic device.

In example fueling plan display 500, the driver intends to start in Denver, CO with 4 gallons of gasoline and drive to their destination in Bozeman, MT. The user may enter preferences and constraints for the fueling plan. For example, the user has input preferences that the fueling stops occur at least more than 100 miles apart. In example fueling plan user interface 500, the display shows a route that is optimizing the fueling stops for the lowest cost for fuel. In some embodiments, fueling plan user interface 500 may be presented to the user when they request it. In some embodiments, fueling plan user interface 500 may be presented to the user when they begin their trip.

In example fueling plan user interface 500, with the preferences and constraints above, the system displays a fueling plan based on a determination that the fuel prices in Cheyenne, WY and Billings, MT are lower than surrounding regions on the route. Trip progress tracker 502 shows the total distance travelled so far on the trip at current progress indicator 506 compared with the total distance of the trip so that a user can tracker their total progress.

Fuel level chart 508 tracks the fuel level of the vehicle throughout the trip. The amount of fuel is represented on the y-axis. For example, the amount of fuel is shown in gallons of gasoline. In some embodiments, the amount of fuel may be shown as a percent charge for an electric vehicle. The distance travelled is shown on the x-axis. For example, the distance is shown in miles. Fuel level graph line 507 shows the fuel level for different points in the trip. Current progress indicators 506 show the current progress into the trip. On fuel level graph line 507, portions before current progress indicator 506 show the previous fuel level at those points in the trip and portions after current progress indicator 506 show the planned fuel amounts for the remainder of the trip. Stop indicator 503 indicates a planned stop in Cheyenne, WY when the vehicle has run out of fuel and stop indicator 504 indicates a planned stop in Billings, MT and the vehicle has run out of fuel. At these stops, the planned amount of fuel or actually obtained amount of fuel are indicated. For example, at the previous stop in Cheyenne, WY, 16 gallons of gasoline were obtained by the user. For example, at the planned stop in Billings, MT, the fueling plan recommends the user purchase 5 gallons of gasoline.

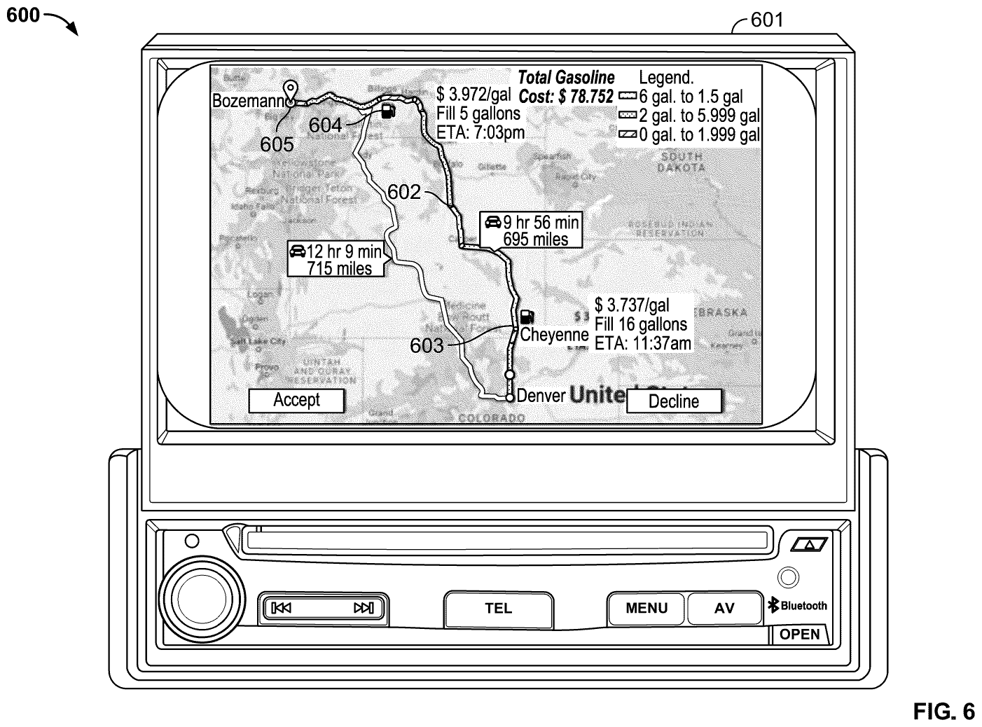

FIG. 6 shows a fueling plan user interface presented to a user in a map view based on progress, in accordance with some embodiments of the disclosure. Display 601 is shown as an automotive original equipment manufacturer (OEM) device which is directly integrated with the vehicle. In an embodiment, the fueling plan may be presented to the user on a display on a personal device such as a smart phone, tablet, laptop, computer, or any other personal electronic device.

In example fueling plan display 600, the driver intends to start in Denver, CO and drive to their destination in Bozeman, MT. The user may enter preferences and constraints for the fueling plan. For example, the user has input preferences that the fueling stops occur at least more than 100 miles apart. In example fueling plan user interface 600, the display shows a route that is optimizing the fueling stops for the lowest cost for fuel. In some embodiments, fueling plan user interface 600 may be presented to the user when they request it. In some embodiments, fueling plan user interface 600 may be presented to the user when they begin their trip. In an embodiment, example fueling plan display 600 may also include an amount of fuel to be purchased at each fueling location.

In example fueling plan user interface 600, with the preferences and constraints above, the system displays a fueling plan based on a determination that the fuel prices in Cheyenne, WY and Billings, MT are lower than surrounding regions on the route. Route line 602 shows the user the route which will be taken on the trip. Stop indicator 603 indicates a planned stop in Cheyenne, WY and stop indicator 604 indicates a planned stop in Billings, MT. In some embodiments, route line 602 may indicate a current progress of the trip. In some embodiments, route line 602 may indicate the fuel level at different points in the trip by a gradient. In some embodiments, stop indicator 603 and stop indicator 604 may indicate if the user has already stopped at that location. In some embodiments, stop indicator 603 and stop indicator 604 may indicate how much fuel was purchased at the stop.

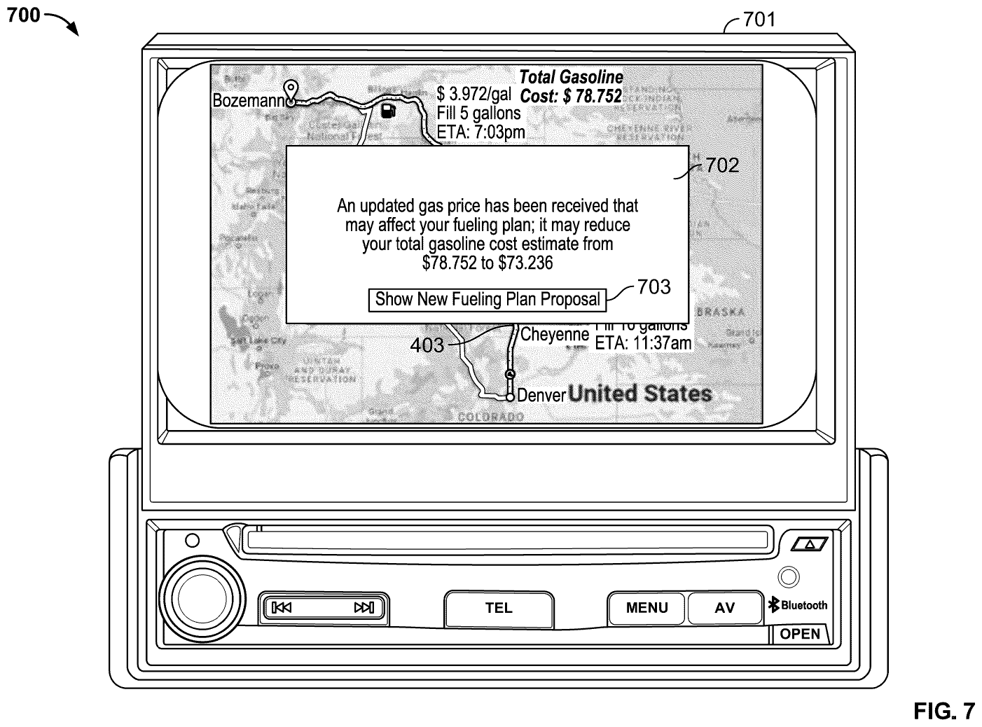

FIG. 7 shows an exemplary overlay on a fueling plan user interface with an updated fuel price for the trip which has decreased, in accordance with some embodiments of the disclosure. Display 701 is shown as an automotive original equipment manufacturer (OEM) which is directly integrated with the vehicle. In an embodiment, the fueling plan may be presented to the user on a display on a personal device such as a smart phone, tablet, laptop, computer, or any other personal electronic device.

The fuel price at a fueling location may fluctuate. In example fueling plan display 700, overlay 702 contains an updated price for fuel which has decreased the total price for fuel on the trip. Option indicator 703 allows a user to see a new fueling plan proposal for their trip which includes this new price.

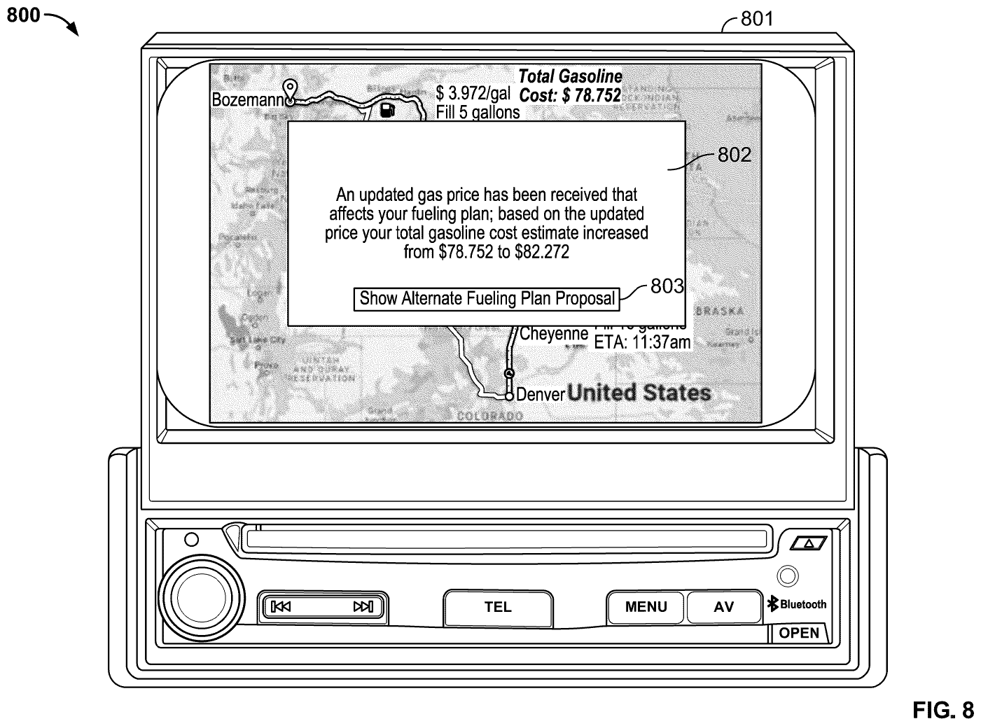

FIG. 8 shows an exemplary overlay on a fueling plan user interface with an updated fuel price for the trip which has increased, in accordance with some embodiments of the disclosure. Display 801 is shown as an automotive original equipment manufacturer (OEM) device. which is directly integrated with the vehicle. In an embodiment, the fueling plan may be presented to the user on a display on a personal device such as a smart phone, tablet, laptop, computer, or any other personal electronic device.

The fuel price at a fueling location may fluctuate. In example fueling plan display 800, overlay 802 contains an updated price for fuel which has increased the total price for fuel on the trip. Option indicator 803 allows a user to see a new fueling plan proposal for their trip which includes this new price.

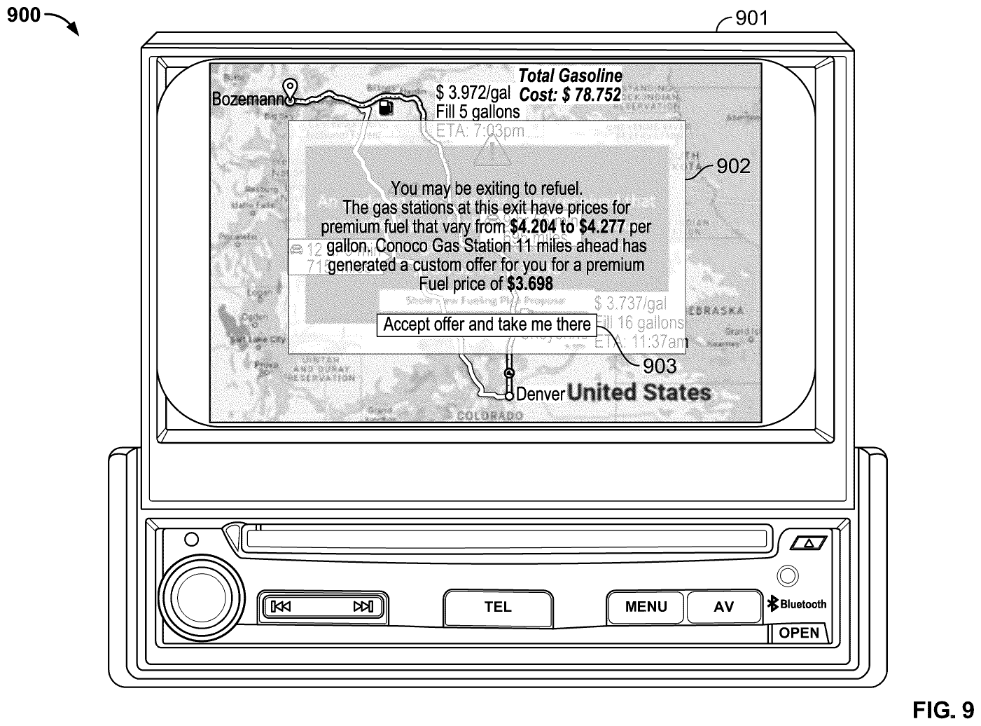

FIG. 9 shows an exemplary overlay on a fueling plan user interface with a custom offer for a discount on fuel, in accordance with some embodiments of the disclosure. Display 901 is shown as an automotive original equipment manufacturer (OEM) which is directly integrated with the vehicle. In an embodiment, the fueling plan may be presented to the user on a display on a personal device such as a smart phone, tablet, laptop, computer, or any other personal electronic device.

In example fueling plan display 901, overlay 902 contains a personalized offer for a discount on fueling price. Overlay 902 contains the price range for fuel at the planned stop. For example, the overlay states that fueling locations at the exit range from $4.204 to $4.277 per gallon. Overlay 902 contains an offer for fuel for $3.698 at a location which is 11 miles further along the route. Option 903 allows a user to accept the personalized offer and be routed to the newly selected fueling location.

In some embodiments, a fueling location may generate a personalized offer to a user to incentivize purchase fuel at the fueling location. In some embodiments, this personalized offer may incentivize the user to update their fueling plan to include the fueling location. In some embodiments, the personalized offer may be time bound. For example, the personalized offer may require the user to redeem the offer within 1 hour.

In some embodiments, the user consents to share navigation data such as their location with the navigation application. This navigation data may indicate that the vehicle is within a threshold distance of a fueling location. For example, the vehicle may be within 10 miles of a fueling location. The navigation application may then receive bids for personalized offers or updated prices for fuel. When an updated fuel price is received, based on the user configuration settings, the navigation application recalculates whether a more optimized fueling plan exists from the current location to the destination. If such a plan exists, then it is displayed to the user, requesting their acceptance. If the fuel price of a station that was part of the fuel plan increases, then the navigation map may recalculate an optimized fuel plan based on the updates, that may not include the previously listed gas station.

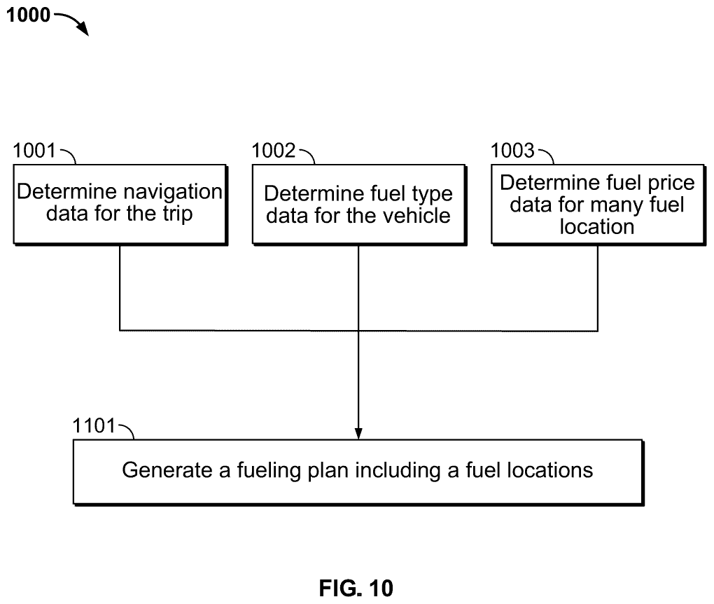

FIG. 10 shows a flowchart of illustrative steps involved in generating a fueling plan in accordance with some embodiments of the disclosure. Process 1000 may be implemented on an automotive original equipment manufacturer (OEM) which is directly integrated with the vehicle or a personal device such as a smart phone, tablet, laptop, computer, or any other personal electronic device.

At 1001, the system determines navigation data for the trip. Navigation data may include a starting point for the trip, a destination, stops along the way, possible routes between the starting point and destination, traffic data, driver preference for a route, a driver profile, and/or any other data useful for navigating the trip. At 1002, the system determines fuel type data for the vehicle. Fuel type data may include determining the type of fuel the vehicle in use operates with. At 1003, the system determines fuel price data for many fuel locations. Fuel price data may include prices for fuel from multiple fueling locations. These prices may be provided by the fueling locations themselves or crowdsourcing. In an embodiment, fuel price data may include an offer from a particular fueling location for a discount.

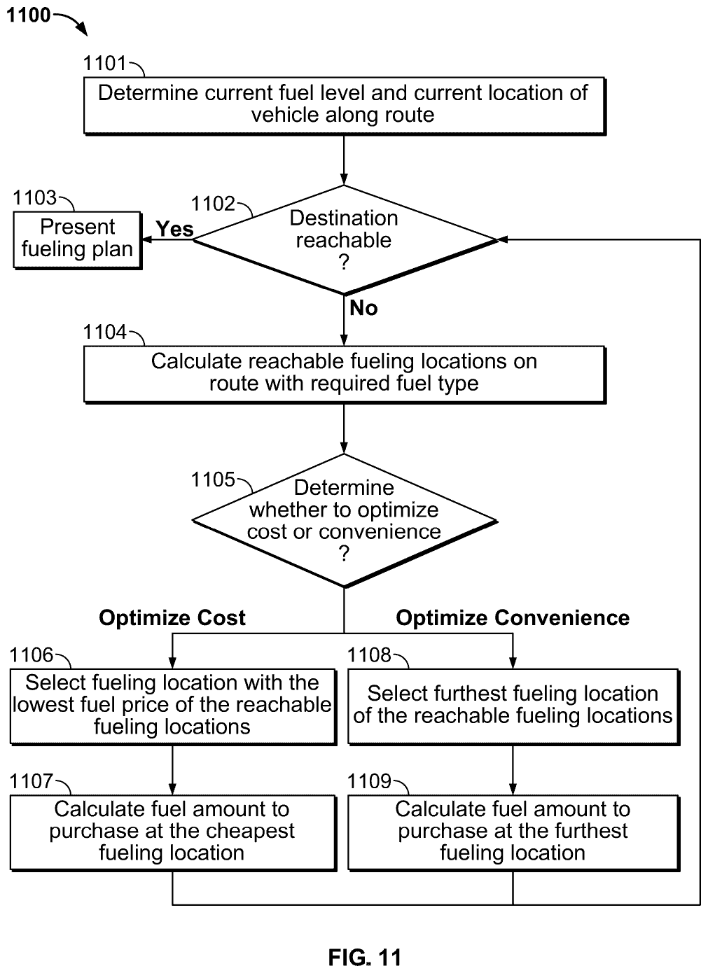

FIG. 11 shows a flowchart of illustrative steps involved in generating a fueling plan based on minimizing cost or maximizing convenience, in accordance with some embodiments of the disclosure. Process 1100 may be implemented on an ECU device which is directly integrated with the vehicle or a processor in a personal device such as a smart phone, tablet, laptop, computer, or any other personal electronic device.

At 1101, the system determines the current fuel level and current location of the vehicle along the route. At 1102, the system determines if the destination is reachable. In some embodiments, the system may use the current fuel level, distance to the destination, average fuel consumption, or any other inputs to determine reachability. If the destination is determined to be reachable, the system presents the fueling plan at 1103. If the destination is determined to not be reachable, the system calculates what fueling locations with the required fuel type are reachable along the route at 1104. In some embodiments, the reachable fueling locations are based on the tank capacity, estimated fuel consumption rate, and/or the distance to the fueling locations.

At 1105, the system determines whether to optimize cost or convenience. A fueling plan may prioritize minimizing cost of the trip or a maximizing user convenience of the trip. In some embodiments, maximum convenience is optimizing for the minimum time of the trip. In some embodiments, maximum convenience is minimizing the number of fuel fill ups. In some embodiments, maximum convenience is optimizing for the minimum distance of the trip. In some embodiments, the system may be preconfigured to optimize cost. In some embodiment, the optimization maybe selected based on user preference. In some embodiments, user preference may be determined based on user input. In some embodiments, user preference may be determined based on a driver profile.

If the system determines it will optimize cost, at 1106 it selects the fueling location with the lowest fuel price of the reachable fueling locations. At 1107, the system calculates the fuel amount to purchase at the determined fueling location. In some embodiments, instead of recommending purchasing the maximum amount of the fuel capacity, the system may minimize the cost of the trip using a greedy algorithm to optimize cost. The greedy algorithm determines the next cheapest fueling location which is reachable within the maximum range and recommends filling the amount of fuel required to reach the next cheapest fueling location. In some embodiments, the system may determine that there is residual fuel left in the tank currently and recommend filling the amount to reach the total needed to arrive at the next destination. This strategy leads to stopping at more fueling locations than necessary in order to minimize cost. In some embodiments, a convenience constraint may be implemented on top of minimizing cost. For example, a maximum number of fueling stops along the route may be set. For example, a minimum distance may be set between fueling stops.

If the system determines it will optimize convenience, at 1108 it selects the fueling location which is the furthest of the reachable fueling locations. In some embodiments, an additional constraint is implemented which only selects fueling locations within a threshold distance away from the route. For example, the fueling location must be within 1 mile of the route. At 1109, the system determines the amount of fuel to acquire at the selected fueling location. In some embodiments, the system suggests that the user purchase the maximum capacity of fuel at the fueling location. If the destination is still not reachable with the full capacity, then it iterates until the destination can be reached. For each iteration, it calculates the reachable set and selects the furthest gas station in this set as the fueling point, recommending a fill-up to capacity.

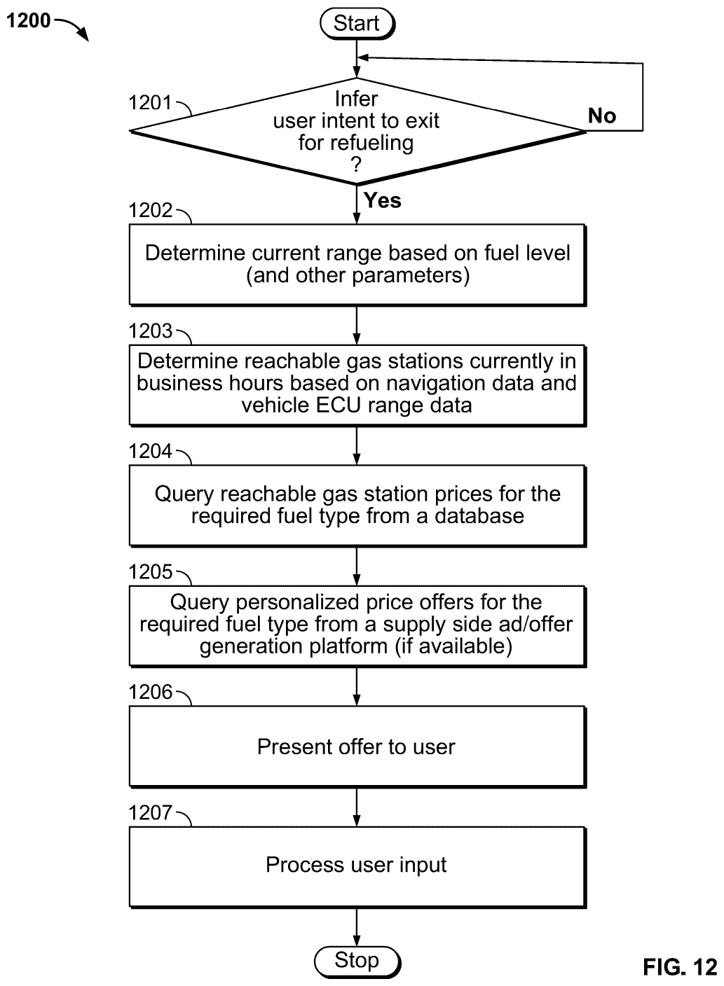

FIG. 12 shows a flowchart of illustrative steps involved in receiving fueling price data, in accordance with some embodiments of the disclosure. Process 1200 may be implemented on an automotive original equipment manufacturer (OEM) device which is directly integrated with the vehicle or a personal device such as a smart phone, tablet, laptop, computer, or any other personal electronic device. While process 1200 is depicted as including a start and a stop, the process may be implemented in or within one or more processes and is not limited to starting and/or stopping as depicted.

At 1201, the system infers the user's intent to refuel. In some embodiments, this intent is inferred based on an existing fueling plan. In some embodiments, this intent is inferred without a fueling plan. For example, the user intent may be determined based on that the fuel is below a certain threshold. For example, the user intent may be determined based on user behavior such as changing lanes towards an exit, a query for a gas station, a reduction in speed, and/or using a turn indicator or signal.

If it is determined that the user has an intent to refuel, at 1202 the system determines the current range of the vehicle based on fuel level and any other parameters. At 1203, the system determines fueling stations within the current range. In some embodiments, the fueling locations are filtered by business hours. At 1204, the system determines prices for fuel at the fueling locations. In some embodiments, these prices are determined from a database or crowdsourcing. At 1205, additional prices include personalized offers for discounts. At 1206, the personalized offer is presented to the user. In some embodiments, the offer may be presented in an overlay as shown in FIG. 9. At 1207, the user inputs an acceptance or denial of the offer. In some embodiments, the offer may be presented as Option 903 as shown in FIG. 9.

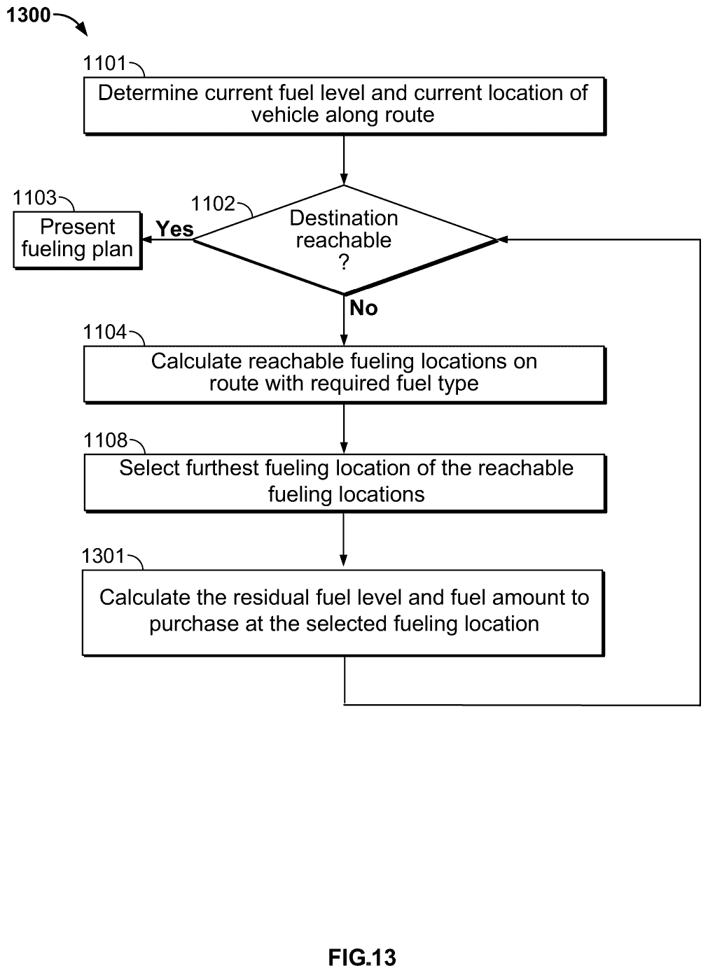

FIG. 13 shows a flowchart of illustrative steps involved in generating a fueling plan based on maximizing convenience for a trip, in accordance with some embodiments of the disclosure. Process 1300 may be implemented on an ECU device which is directly integrated with the vehicle or a processor in a personal device such as a smart phone, tablet, laptop, computer, or any other personal electronic device.

Process 1300 begins the same way as process 1100 described in connection with FIG. 11. At 1101, the system determines the current fuel level and current location of the vehicle along the route. At 1102, the system determines if the destination is reachable. In some embodiments, the system may use the current fuel level, distance to the destination, average fuel consumption, or any other inputs to determine reachability. If the destination is determined to be reachable, the system presents the fueling plan at 1103. If the destination is determined to not be reachable, the system calculates what fueling locations with the required fuel type are reachable along the route at 1104. In some embodiments, the reachable fueling locations are based on the tank capacity, estimated fuel consumption rate, and/or the distance to the fueling locations.

Process 1300 is selected to maximize convenience for the trip. Therefore, at 1108, it selects the fueling location which is the furthest of the reachable fueling locations. In some embodiments, an additional constraint is implemented which only selects fueling locations within a threshold distance away from the route. For example, the fueling location must be within 1 mile of the route. At 1301, the system determines the residual amount of fuel leftover when the selected fueling location is reached and the amount of fuel to acquire at the selected fueling location. In some embodiments, the residual amount of fuel is calculated as the current amount of fuel less the anticipated amount of fuel consumption before reaching the selected fueling location. In some embodiments, the anticipated amount of fuel consumption before reaching the selected fueling location is based on the distance between the current location and selected fueling location. In some embodiments, the system suggests that the user purchase the maximum capacity of fuel at the fueling location. If the destination is still not reachable with the full capacity, then it iterates until the destination can be reached. For each iteration, it calculates the reachable set and selects the furthest gas station in this set as the fueling point, recommending a fill-up to capacity.

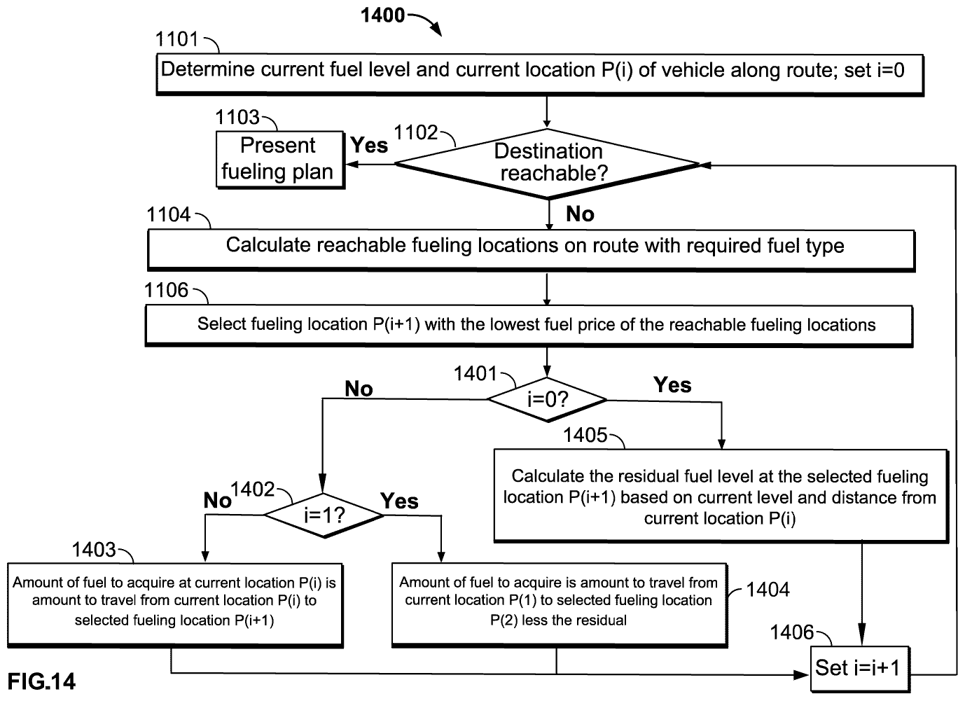

FIG. 14 shows a flowchart of illustrative steps involved in generating a fueling plan based on minimizing cost for a trip, in accordance with some embodiments of the disclosure. Process 1400 may be implemented on an ECU device which is directly integrated with the vehicle or a processor in a personal device such as a smart phone, tablet, laptop, computer, or any other personal electronic device.

Process 1400 begins the same way as process 1100 described in connection with FIG. 11. At 1101, the system determines the current fuel level and current location P(i) of the vehicle along the route. Additionally, an iteration counter ‘i’ is set to zero. At 1102, the system determines if the destination is reachable. In some embodiments, the system may use the current fuel level, distance to the destination, average fuel consumption, or any other inputs to determine reachability. If the destination is determined to be reachable, the system presents the fueling plan at 1103. If the destination is determined to not be reachable, the system calculates what fueling locations with the required fuel type are reachable along the route at 1104. In some embodiments, the reachable fueling locations are based on the tank capacity, estimated fuel consumption rate, and/or the distance to the fueling locations.

Process 1400 is an optimization process to minimize cost for the trip. Therefore, at 1106 it selects the fueling location P(i+1) with the lowest fuel price of the reachable fueling locations.

At 1401, the value of the iteration counter ‘i’ is checked. If iteration counter ‘i’ is zero, this is the first iteration. Then, at 1405, the residual fuel level at the selected fueling location P(i+1) is calculated. In some embodiments, the residual amount of fuel is calculated as the current amount of fuel less the anticipated amount of fuel consumption before reaching the selected fueling location. In some embodiments, the anticipated amount of fuel consumption before reaching the selected fueling location is based on the distance between the current location and selected fueling location. At 1406, the iteration counter ‘i’ is updated by adding one to the value and the process returns to 1102 to determine if the destination is reachable.

At 1401, the value of the iteration counter ‘i’ is checked. If iteration counter ‘i’ is not zero, then the amount of fuel to purchase to get to the selected fueling location needs to be determined. At 1402 the value of the iteration counter ‘i’ is checked again. If iteration counter ‘i’ is one, this is the second iteration. Therefore, the vehicle has started with an amount of fuel and there will be a residual amount of fuel when the selected fueling location P(2) is reached, as calculated at 1405. Therefore, at 1404 the amount of fuel to acquire is the fuel required to travel from current location P (1) to the selected fueling location P(2) less the residual fuel. If, at 1402, iteration counter ‘i’ is not one, this is a later iteration. Therefore, there should not be a residual amount of fuel because the amount purchased at the previous fueling location was calculated to reach the selected fueling location. Therefore, at 1403 the amount of fuel to acquire is the fuel required to travel from current location P(i) to the selected fueling location P(i+1). In some embodiments, due to errors in the residual fuel calculation, the actual amount of residual fuel may be nonzero when the vehicle reaches the selected fueling location and this actual residual amount may be accounted for when selecting the amount of fuel to acquire.

In some embodiments, a convenience constraint may be implemented to constrain process 1400. For example, a maximum number of fueling stops along the route may be set. For example, a minimum distance may be set between fueling stops.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method for optimizing a fueling plan comprising:
determining navigation data for a trip;
determining fuel type data for a vehicle;
determining fuel price data for a plurality of fuel locations within a geographic threshold of the trip; and
generating a fueling plan based on the navigation data, fuel type data, and fuel price data, wherein the fueling plan comprises a selected fuel location of the plurality of fuel locations.

2. The method of claim 1 further comprising:
determining, based on the fuel type data, that the vehicle cannot reach the selected fuel location; and
in response to the determining, automatically configuring the vehicle to reduce fuel consumption.

3. The method of claim 2 wherein automatically configuring the vehicle to reduce fuel consumption comprises one or more of limiting acceleration of the vehicle, limiting speed of the vehicle, or modifying the operation of non-critical systems which consume fuel.

4. The method of claim 1 further comprising:
automatically configuring a fuel pump at the selected fuel location with one or more of the fuel type data for the vehicle or an amount of fuel.

5. The method of claim 1 wherein determining navigation data for the trip comprises receiving one or more of a destination, a starting location, a plurality of routes, traffic data, or road condition data.

6. The method of claim 1 wherein the navigation data comprises a driver profile.

7. The method of claim 6 wherein the driver profile comprises a user preference to minimize a cost for the trip and wherein generating the fueling plan comprises determining a route based on the user preference to minimize the cost for the trip.

8. The method of claim 6 wherein the driver profile comprises a user preference to minimize a duration for the trip and wherein generating the fueling plan comprises determining a route based on the user preference to minimize the duration for the trip.

9. The method of claim 1 wherein determining fuel type data for a vehicle comprises determining one or more of a vehicle type, a vehicle VIN, a preferred fuel composition for the vehicle, a current fuel level, or a vehicle weight.

10. The method of claim 1 wherein determining fuel price data for a plurality of fuel locations comprises receiving an offer for a discount on fuel at a first fueling location of the plurality of fuel locations.

11. A system comprising:
an engine control unit (ECU) configured to determine fuel type data for a vehicle;
control circuitry configured to:
determine navigation data for a trip;
determine fuel price data for a plurality of fuel locations within a geographic threshold of the trip; and
generate a fueling plan based on the navigation data, fuel type data, and fuel price data, wherein the fueling plan comprises a selected fuel location of the plurality of fuel locations.

12. The system of claim 11 wherein the control circuitry is further configured to:
determine, based on the fuel type data, that the vehicle cannot reach the selected fuel location; and
in response to the determining, automatically configure the vehicle to reduce fuel consumption.

13. The system of claim 11 wherein the control circuitry is further configured to, when automatically configuring the vehicle to reduce fuel consumption, perform one or more of limiting acceleration of the vehicle, limiting speed of the vehicle, or modifying the operation of non-critical systems which consume fuel.

14. The system of claim 11 wherein the control circuitry is further configured to automatically configure a fuel pump at the selected fuel location with one or more of the fuel type data for the vehicle and an amount of fuel.

15. The system of claim 11 wherein the control circuitry is further configured to, when determining navigation data for the trip, receive one or more of a destination, a starting location, a plurality of routes, traffic data, or road condition data.

16. The system of claim 11 wherein the control circuitry is further configured to, when determining navigation data, receive a driver profile.

17. The system of claim 16 wherein the control circuitry is configured to receive a driver profile comprising a user preference to minimize a cost for the trip and when generating the fueling plan, determine a route based on the user preference to minimize the cost for the trip.

18. The system of claim 16 wherein the control circuitry is configured to receive a driver profile comprising a user preference to minimize a duration for the trip and when generating the fueling plan, determine a route based on the user preference to minimize the duration for the trip.

19. The system of claim 11 wherein the ECU is further configured to, when determining fuel type data for the vehicle, determine one or more of a vehicle type, a vehicle VIN, a preferred fuel composition for the vehicle, a current fuel level, or a vehicle weight.

20. The system of claim 11 wherein the control circuitry is further configured to, when determining fuel price data for a plurality of fuel locations, receive an offer for a discount on fuel at a first fueling location of the plurality of fuel locations.
